(19) United States
(12) Patent Application Publication
(10) Pub. No.: US 2006/0244726 A1
(43) Pub. Date: Nov. 2, 2006

(54) WIRELESS INPUT DEVICE

(75) Inventors: Yung-Hui Wang, TAIPEI (TW); Kuan-Hung Chen, TAIPEI (TW)

Correspondence Address: PATEN WIRELESS TECHNOLOGY INC., 2F-4, NO. 148, SEC. 4, CHUNG HSIAO EAST ROAD, TAIPEI, TW

(73) Assignee: PATEN WIRELESS TECHNOLOGY INC., Taipei City (TW)

(21) Appl. No.: 11/164,851

(22) Filed: Dec. 7, 2005

(30) Foreign Application Priority Data
Dec. 8, 2004 (TW) 093137940
Jan. 21, 2005 (TW) 094101825

(51) Int. Cl. G09G 5/08

(52) U.S. Cl. 345/163

(57) ABSTRACT

A wireless input device is disclosed to include a housing, which has a top cover shell and a bottom cover shell relatively slidably coupled together, a first cursor control device, which is mounted in the top cover shell for operation by the user and has an input unit and an input control unit for operation by the user to produce input signals and a sensor mounted in the bottom cover shell for detecting movement of the housing on a surface, and a second cursor control device, which is mounted inside the housing and has a direction control unit mounted in said bottom cover shell and adapted to control the movement of a cursor on a display screen and an orientation unit mounted in the bottom cover shell for control the emitting of a laser beam for pointing.

This application claims the priority benefit of Taiwan patent application number 093137940 filed on Dec. 8, 2004 and Taiwan patent application number 094101825 filed on Jan. 21, 2005.

### BACKGROUND OF THE INVENTION

1. Field of the Invention

The present invention relates to wireless input device and more particularly, to such a wireless input device, which is a combination of a wireless mouse, a laser pointer, a presentation work system, and a manual-operated remote controller.

2. Description of the Related Art

Following fast development of electronic technology, most electronic products have a remote control function. This remote control function is insufficient to compete in the market. Many advanced electronic products provide a laser pointer or presentation work system. These combination electronic products may be used with a computer to make a presentation. Further, a video system or projector may be used with different peripheral apparatus such as remote controller or laser pointer when making a presentation. The remote controller is for volume and image controls. The pointer is for pointing out things on the screen at a distance. Various presentation peripheral apparatus have been disclosed. These presentation peripheral apparatus cannot achieve a presentation work independently. When making a presentation, the user still needs to use many presentation peripheral apparatus, i.e., the use of the aforesaid presentation peripheral apparatus has the following drawbacks.
1. A different presentation peripheral apparatus must be used to control the computer to run a different function, and a wrong presentation peripheral apparatus cannot drive the computer to run the desired function.
2. The use of many different presentation peripheral apparatus requires much installation and storage space.
3. It is expensive to prepare many different presentation peripheral apparatus for use with a computer.

According to this design, as shown in FIG. 14, the remote controller A has a first set of function buttons A1 and an optical sensor A2 at one side, a second set of function buttons A3 at the other side, and a wireless transmitting circuit A4 on the inside. The wireless transmitting circuit A4 sends the control signal produced by one of the control buttons A1 and A3 wirelessly to a wireless receiving circuit B1 of a wireless receiver B, which is connected to a computer C through an interface B2, allowing the computer C to control the operation of a projector C1, causing the projector C1 to project the set data on a screen D.

The use of the aforesaid remote controller A has numerous drawbacks as outlined hereinafter.
1. Because the remote controller has function buttons on the top and bottom sides, the user may trigger the function buttons accidentally to output a false signal.
2. The first set of function buttons, the second set of function buttons and the optical sensor occupy much installation space, and therefore the size of the remote controller cannot be minimized.
3. The remote controller provides only a cursor control function, and the computer may have to be used with other peripheral apparatus.

Therefore, it is desirable to provide a wireless input device, which eliminates the aforesaid drawbacks.

### SUMMARY OF THE INVENTION

The present invention has been accomplished under the circumstances in view. It is the main object of the present invention to provide a wireless input device, which is a combination of a wireless mouse, a laser pointer, a presentation work system and a manual-operated remote controller, and practical for use in a presentation, meeting, symposium, speech course, etc., to control the positioning of the cursor on the screen and the scrolling of pages on the screen, to point out things on a map or screen, to control the operation of a projector, etc. According to one aspect of the present invention, the wireless input device comprises a housing, a first cursor control device, a second cursor control device, and a remote control unit. The housing comprises an upper cover shell, and a bottom cover shell coupled to the upper cover shell and movable relative to the top cover shell. The first cursor control device is mounted inside the housing, comprising an input unit mounted in said top cover shell for operation by the user, an input control unit mounted inside the housing and controlled by the input unit to produce input signals, and sensor means mounted in the bottom cover shell for detecting movement of the housing on a reflective surface. The second cursor control device is mounted inside the housing, comprising a direction control unit mounted in the bottom cover shell and adapted to control the movement of a cursor on a display screen, and an orientation control unit mounted in the bottom cover shell. The remote control unit is provided at the bottom cover shell remote from the direction control unit of the second cursor control device.

According to another aspect of the present invention, plate members are respectively affixed to the top and bottom sides of the bottom cover shell of the housing, defining with the bottom cover shell top a holding space and a bottom chamber for accommodating the orientation control unit and the direction control unit of the second cursor control device.

According to another aspect of the present invention, a holder is provided at one side of the housing, defining an accommodating groove for receiving a wireless receiver, which is to be used in an electronic product to receive wireless control signals from the wireless input device. The holder can be set in the top cover shell or the bottom cover shell.

### BRIEF DESCRIPTION OF THE DRAWINGS

FIG. 1 is an oblique top elevation of a wireless input device according to the present invention.

FIG. 2 is an oblique bottom elevation of the wireless input device according to the present invention.

FIG. 3 is an exploded view of the wireless input device according to then present invention.

FIG. 4 is a side view in section of the wireless input device according to the present invention.

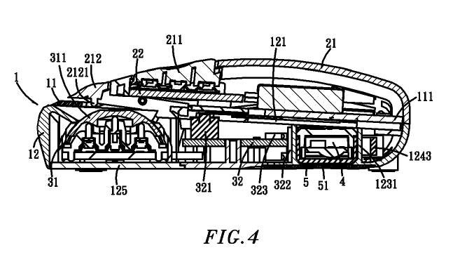

FIG. 5 is an exploded view of a part of the wireless input device according to the present invention, showing the structure of the first plate member and the second plate member.

FIG. 6 is a top plain view of the present invention, showing the wireless receiver received in the housing.

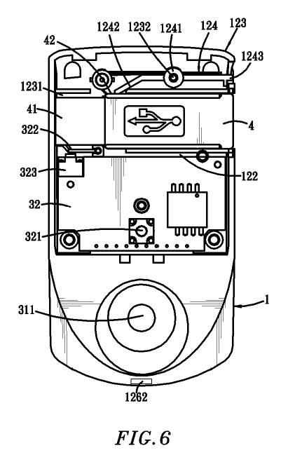

FIG. 7 corresponds to FIG. 6, showing the wireless receiver moved out of the housing.

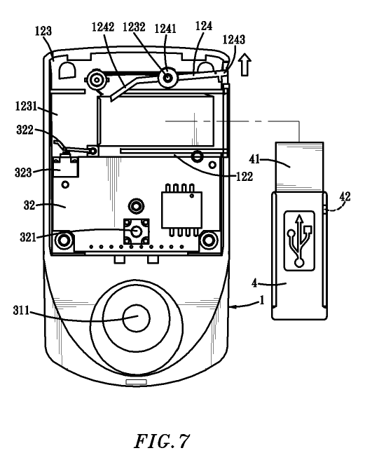

FIG. 8 is another oblique top elevation of the wireless input device according to the present invention, showing the top cover shell moved relative to the bottom cover shell.

FIG. 9 is a side view in section of FIG. 8.

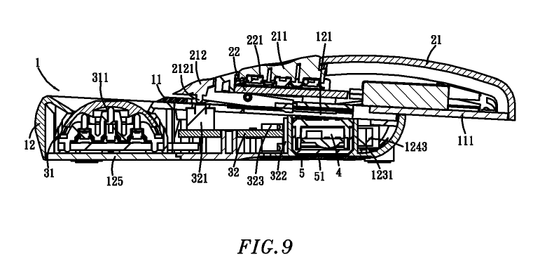

FIG. 10 is an oblique top elevation of a wireless input device according to a second embodiment of the present invention.

FIG. 11 is an oblique bottom elevation of the wireless input device according to the second embodiment of the present invention.

FIG. 12 is a perspective exploded view of the wireless input device according to the second embodiment of the present invention.

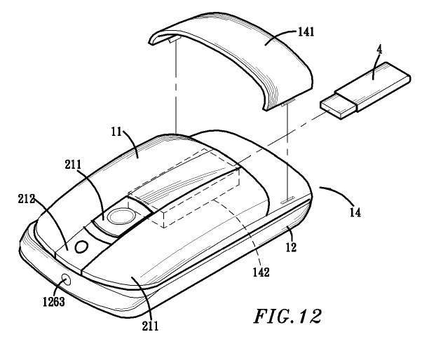

FIG. 13 is a perspective view of a wireless input device according to a third embodiment of the present invention.

FIG. 14 is a schematic drawing showing the use of a wireless presentation pointer and remote controller according to the prior art.

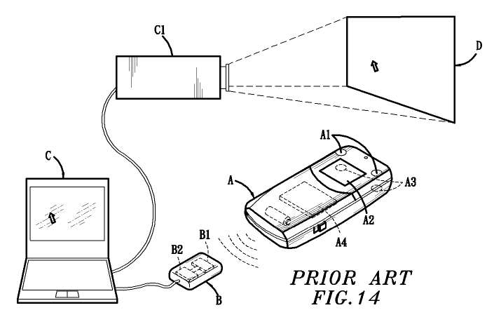

### DETAILED DESCRIPTION OF THE PREFERRED EMBODIMENT

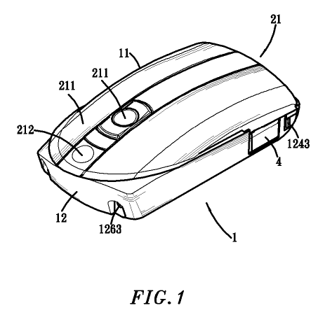

Referring to FIGS. 1˜4, a wireless input device in accordance with the first embodiment of the present invention is shown comprised of a housing 1, a first cursor control device 2, a second cursor control device 3. Further, the wireless input device is to be used with a wireless receiver 4 that is connectable to an electronic product for enabling the wireless input device to control the operation of the electronic product.

The housing 1 comprises a top cover shell 11 and a bottom cover shell 12. The top cover shell 11 has a bottom side mounted with a first plate member 111, which defines with the bottom side of the top cover shell 11 an accommodating chamber 112. Further, the first plate member 111 has coupling members 113. The bottom cover shell 12 has a top side mounted with a second plate member 121, which defines with the top side of the bottom cover shell 12 a holding space 122, and a bottom side mounted with a third plat member 125, which defines with the bottom side of the bottom cover shell 12 a bottom chamber 126. The second plate member 121 has an opening 1211 coupled to the coupling members 113 of the first plate member 111 for allowing movement of the top cover shell 11 relative to the bottom cover shell 12, and a round hole 1212 near one side of the opening 1211. The bottom cover shell 12 has a holder 123, which defines an accommodating groove 1231 inside the holding space 122, a pin 1232 disposed at one side of the accommodating groove 1231, a circular through hole 1261 in the top side in communication with the bottom chamber 126, a lock hole 1262 adjacent to the circular through hole 1261, and a firing hole 1263 at one end, namely the front end. Further, a swivel member 124 is pivotally mounted on the pin 1232. The swivel member 124 has a pivot hole 1241 disposed on the middle and pivotally coupled to the pin 1232, a push rod 1242 at one end, and a retaining rod 1243 at the other end. Further, a return spring 1244 is coupled between the bottom cover shell 12 and the swivel member 124.

The first cursor control device 2 comprises an input unit 21, and an input control unit 22. The input unit 21 comprises a plurality of operation buttons 211, and a directional button 212, which has a bottom plunger 2121. The input control unit 22 is a signal transmission circuit board, having a plurality of buttons 221.

The second cursor control device 3 comprises a direction control unit 31 and an orientation control unit 32. The direction control unit 31 is a signal transmission circuit board, comprising a direction control member 311 that can be operated to output a direction control signal for controlling the amount and direction of movement of a cursor on a display screen, and a laser diode 312 disposed near one side of the direction control member 311. The orientation control unit 32 is a signal transmission circuit board, comprising an actuating member 321, a switching lever 322, and a power switch 323.

The wireless receiver 4 is adapted to receive and transmit signals produced by the wireless input device, having a plug 41 at one end and a retaining groove 42 at one lateral side. By means of the plug 41, the wireless receiver 4 can be connected to an electronic product (computer, game machine, projector, etc.).

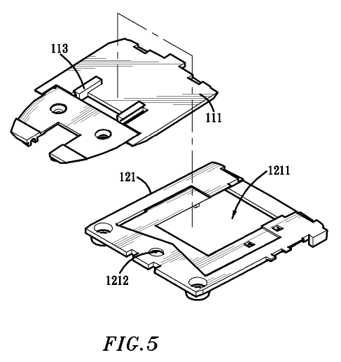

During assembly process, the input unit 21 of the first cursor control device 2 is installed in the top side of the top cover shell 11 of the housing 1 and the input control unit 22 of the first cursor control device 2 is mounted in the accommodating chamber 112 between the top cover shell 11 and the first plate member 121, keeping the operation buttons 211 of the input unit 21 respectively suspending above the buttons 221 of the input control unit 22. Therefore, the user can operate the operation buttons 211 to drive the respective buttons 221 of the input control unit 22, causing the input control unit 22 to output a respective control signal. Further, the coupling members 113 of the first plate member 111 are coupled to the opening 1211 of the second plate member 121 (see FIG. 5), allowing movement of the coupling members 113 with the top cover shell 11 relative to the bottom cover shell 12 within the opening 1211. Further, a sensor 23 is mounted in the bottom side of the bottom cover shell 12 for detecting movement of the housing 1 on a flat surface. The holding space 122 between the second plate member 121 and the bottom cover shell 12 accommodates the orientation control unit 32 of the second cursor control device 3. The actuating member 321 of the orientation control unit 32 is inserted through the round hole 1212 of the second plate member 121. The bottom chamber 126 accommodates the direction control unit 31 of the second cursor control device 3. The direction control member 311 of the direction control unit 31 is suspending in the circular through hole 1261 and coupled to the orientation control unit 32.

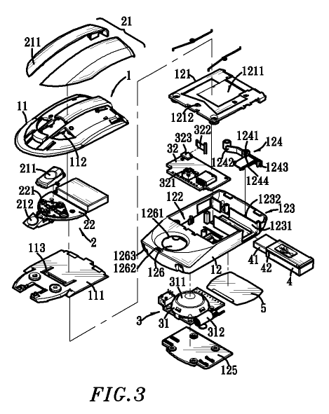

Referring to FIGS. 3˜7, when the top cover shell 11 and bottom cover shell 12 of the housing 1 are assembled, the wireless input device is used with an electronic product for controlling input of the electronic product, i.e., the wireless input device of the present invention can be used as the wireless mouse of a computer, the wireless joystick of a game machine, the wireless remote controller of a video system. By means of the wireless receiver 4 to receive and transmit instruction signals produced by the input unit 21 of the first cursor control device 2 and the displacement signal of the electronic product detected by the sensor 23 of the first cursor control device 2, the wireless input device is used as the input device of the electronic product. When the input device is not used, the wireless receiver 4 is detached from the electronic product, and then inserted into the accommodating groove 1231 in the bottom cover shell 12 of the housing 1 and stopped against the switching lever 322 of the orientation control unit 32 of the second cursor control device 3 to switch off the power switch 323, saving power consumption. When inserting the wireless receiver 4 into the accommodating groove 1231 in the bottom cover shell 12 of the housing 1, the plug 41 of the wireless receiver 4 pushes the push rod 1242 of the swivel member 124 against the spring power of the return spring 1244, enabling the push rod 1242 to be engaged into the retaining groove 42 when the swivel member 124 is returned by the return spring 1244, and at the same time the retaining rod 1243 is pressed on one lateral side of the wireless receiver 4, and therefore the wireless receiver 4 is held down in the accommodating groove 1231.

When pulling the retaining rod 1243 away from the wireless receiver 4, the push rod 1242 of the swivel member 124 is forced to push the wireless receiver 4 out of the accommodating groove 1231. After removal of the wireless receiver 4 from the accommodating groove 1231, the swivel member 124 is returned to its former position by the return spring 1244, and at the same time the switching lever 322 is moved away from the power switch 323, i.e., the switching lever 322 is forced to switch on the power switch 323 (when the switching lever 322 touches the power switch 323, the power switch 323 is off; when the switching lever 322 is moved away from the power switch 323, the power switch 323 is on).

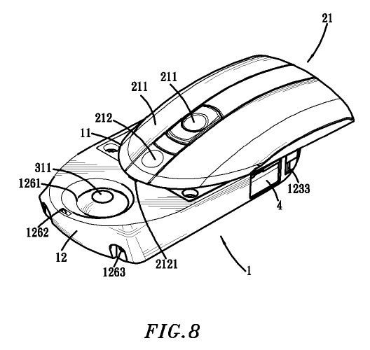

Referring to FIG. 8 and FIG. 1 again, the holder 123 of the bottom cover shell 12 is covered with a cap 1233. When the wireless input device is used, the wireless receiver 4 is inserted into the electronic product to receive the control signal outputted by the wireless input device wirelessly and then to transmit the received control signal to the internal control circuit of the electronic product. When the electronic product is not in use, the wireless receiver 4 is detached from the electronic product and inserted into the accommodating groove 1231 of the holder 123 in the bottom cover shell 12 of the housing 1, and then the cap 1233 is covered on the holder 123 to close the accommodating groove 1231 and to protect the received wireless receiver 4 against outside dust.

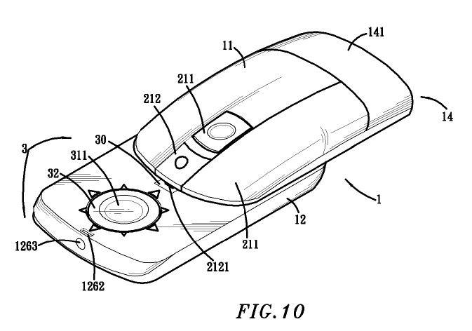

FIGS. 10˜12 show a wireless input device according to the second embodiment of the present invention. According to this embodiment, the holder, referenced by 14, is provided at the top cover shell 11, defining an accommodating groove 142 for receiving the wireless receiver 4 when the wireless input device is not used, and a cap 141 is covered on the holder 14.

Referring to FIGS. 3˜5 and 8˜10, when the top cover shell 11 and bottom cover shell 12 of the housing 1 are assembled, the wireless input device of the present invention can be used as the wireless mouse of a computer, the wireless joystick of a game machine, the wireless remote controller of a video system. When moved the top cover shell 11 relative to the bottom cover shell 12, the bottom plunger 2121 of the directional button 212 of the input unit 21 of the first cursor control device 2 is inserted into the round hole 1212 at the second plate member 121 and suspending above the actuating member 321 of the orientation control unit 32. When the user pressed the directional button 212 of the input unit 21 of the first cursor control device 2 at this time, the bottom plunger 2121 is forced against the actuating member 321 of the orientation control unit 32, causing the actuating member 321 to drive the laser diode 312 to emit a laser beam out of the firing hole 1263 of the bottom cover shell 12. By means of the laser beam from the laser diode 312 and the operation of the direction control unit 31, the invention can be used in a presentation work to control the operation of a computer, projector, or video system. In this case, the direction control member 311 of the direction control unit 31 is operated to achieve cursor positioning, pointing, page scrolling and browsing functions. In general, the wireless input device of the present invention achieves the functions of a cursor control device, a laser pointer and a wireless remote controller.

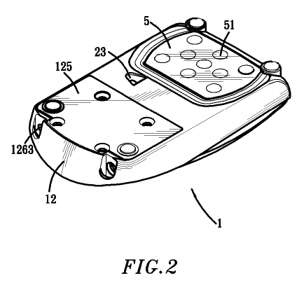

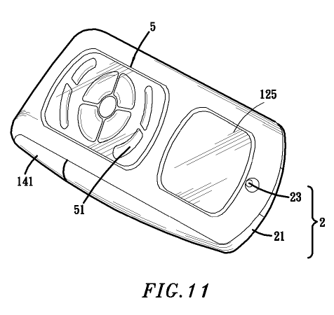

Referring to FIG. 11 and FIGS. 1 and 2 again, a remove control unit 5 may be provided at the bottom side of the bottom cover shell 12. The remote control unit 5 is a recessed member having a plurality of control buttons 51 for inputting different instruction signals to control power, voice volume, window shifting, e-mail receiving and sending functions of a CD/VCD/DVD player, electronic video system, or digital TV. By means of the remote control unit 5, the invention can be used as a manual-operated remote controller. Further, the control buttons 51 of the remote control unit 5 can be arranged in vertical or horizontal, or around a circle.

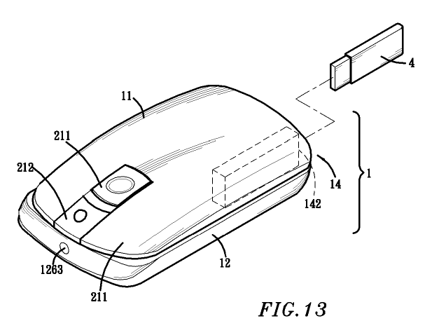

FIG. 13 shows a wireless input device constructed according to the third embodiment of the present invention. This embodiment is substantially to the aforesaid second embodiment of the present invention. According to this embodiment, the accommodating chamber 142 is defined in the top cover shell 11 near one lateral side for allowing insertion of the wireless receiver 4 in horizontal and for holding the wireless receiver 4 in a vertical position.

As indicated above, the invention provides a wireless input device, which has the following advantages.
1. The housing houses a first cursor control unit, a second cursor control unit and a remote control unit, allowing the wireless input device to be used as a wireless mouse, a laser pointer, as well as a remote controller.
2. The housing has an accommodating groove for receiving the wireless receiver when the wireless input device is not used, and the wireless receiver automatically switches off the power supply of the wireless input device when inserted into the accommodating groove of the housing of the wireless input device.
3. The wireless input device is a combination of multiple peripheral apparatus, which saves the installation cost of many peripheral apparatus to be used with an electronic product that is controllable by the wireless input device of the present invention.
4. The housing has accommodating chambers and holding spaces defined in the top cover shell and the bottom cover shell to accommodate the first cursor control unit, the second cursor control unit and the wireless receiver. This compact design fits the requirements for electronic products having light, thin, small and short characteristics.
5. The handy wireless input device is a combination of a wireless mouse, a laser pointer, a presentation work system, and a manual-operated remote controller, practical for use in a presentation, meeting, symposium, speech course, etc., to control the positioning of the cursor on the screen and the scrolling of pages on the screen, to point out things on a map or screen, to control the operation of a projector, etc.

Although particular embodiments of the invention have been described in detail for purposes of illustration, various modifications and enhancements may be made without departing from the spirit and scope of the invention.

What is claimed is:

1. A wireless input device comprising:
a housing, said housing comprising a top cover shell and a bottom cover shell;
a first cursor control device mounted inside said housing, said first cursor control device comprising an input unit mounted in said top cover shell for operation by the user, an input control unit mounted inside said housing and controlled by said input unit to produce input signals, and sensor means mounted in said bottom cover shell for detecting movement of said housing on a reflective surface; and
a second cursor control device mounted inside said housing, said second cursor control device comprising a direction control unit mounted in said bottom cover shell and adapted to control the movement of a cursor on a display screen, and an orientation control unit mounted in said bottom cover shell.

2. The wireless input device as claimed in claim 1, wherein said housing comprises a holder provided at one of said top cover shell and said bottom cover shell remote from said direction control unit, said holder defining an accommodating groove adapted to receive a wireless receiver to be used with an electronic product to receive wireless signal from said first cursor control device and said second cursor control device.

3. The wireless input device as claimed in claim 1, wherein said housing further comprises a first plate member affixed to a bottom side of said top cover shell, said first plate member defining with said top cover shell an accommodating chamber for accommodating said input control unit of said first cursor control device, and a second plate member affixed to a top side of said bottom cover shell and coupled to said first plate member for allowing movement of said top cover shell relative to said bottom cover shell, said second plate member defining with said bottom cover shell a holding space, which accommodates said orientation control unit of said second cursor control device.

4. The wireless input device as claimed in claim 3, wherein said housing further comprises a third plate member affixed to a bottom side of said bottom cover shell and defining with said bottom cover shell a bottom chamber, which accommodates said direction control unit of said second cursor control device.

5. The wireless input device as claimed in claim 3, said direction control unit of said second cursor control device comprises a laser diode; said orientation control unit of said second cursor control device comprises an actuating member adapted to drive said laser diode to emit a laser beam, a power switch, and a switching lever adapted to switch on/off said power switch.

6. The wireless input device as claimed in claim 3, wherein said direction control unit of said second cursor control device comprises a directional control member adopted to output a respective control signal for controlling the amount and direction of movement of a cursor on a display screen.

7. The wireless input device as claimed in claim 1, wherein said input unit of said first cursor control device comprises a plurality of operation buttons and direction buttons.

8. The wireless input device as claimed in claim 1, wherein said input control unit of said first cursor control device comprises a plurality of buttons.

9. The wireless input device as claimed in claim 1, wherein said sensor means is an optical sensor or a mechanical sensor.

10. A wireless input device comprising a housing, a first cursor control device, a second cursor control device, and a remote control unit, wherein:
said housing comprises an upper cover shell and a bottom cover shell coupled to said upper cover shell and movable relative to said top cover shell;
said first cursor control device is mounted inside said housing, said first cursor control device comprising an input unit mounted in said top cover shell for operation by the user, an input control unit mounted inside said housing and controlled by said input unit to produce input signals, and sensor means mounted in said bottom cover shell for detecting movement of said housing on a reflective surface;
said second cursor control device is mounted inside said housing, said second cursor control device comprising a direction control unit mounted in said bottom cover shell and adapted to control the movement of a cursor on a display screen, and an orientation control unit mounted in said bottom cover shell;
said remote control unit is provided at said bottom cover shell remote from said direction control unit of said second cursor control device.

11. The wireless input device claimed in claim 10, wherein said housing comprises a holder provided at one of said top cover shell and said bottom cover shell remote from said direction control unit, said holder defining an accommodating groove adapted to receive a wireless receiver to be used with an electronic product to receive wireless signal from said first cursor control device and said second cursor control device.

12. The wireless input device as claimed in claim 10, wherein said housing further comprises a first plate member affixed to a bottom side of said top cover shell, said first plate member defining with said top cover shell an accommodating chamber for accommodating said input control unit of said first cursor control device, and a second plate member affixed to a top side of said bottom cover shell and coupled to said first plate member for allowing movement of said top cover shell relative to said bottom cover shell, said second plate member defining with said bottom cover shell a holding space, which accommodates said orientation control unit of said second cursor control device.

13. The wireless input device as claimed in claim 12, wherein said housing further comprises a third plate member affixed to a bottom side of said bottom cover shell and defining with said bottom cover shell a bottom chamber, which accommodates said direction control unit of said second cursor control device.

14. The wireless input device as claimed in claim 12, said direction control unit of said second cursor control device comprises a laser diode; said orientation control unit of said second cursor control device comprises an actuating member adapted to drive said laser diode to emit a laser beam, a power switch, and a switching lever adapted to switch on/off said power switch.

15. The wireless input device as claimed in claim 12, wherein said direction control unit of said second cursor control device comprises a directional control member for producing a respective control signal.

16. The wireless input device as claimed in claim 10, wherein said input unit of said first cursor control device comprises a plurality of operation buttons and direction buttons.

17. The wireless input device as claimed in claim 10, wherein said input control unit of said first cursor control device comprises a plurality of buttons.

18. The wireless input device as claimed in claim 10, wherein said sensor means is an optical sensor or a mechanical sensor.

19. The wireless input device as claimed in claim 10, wherein said remote control unit is a recessed device, having a plurality of operation buttons.
